(19) United States
(12) Patent Application Publication
(10) Pub. No.: US 2008/0021905 A1
(43) Pub. Date: Jan. 24, 2008

(54) Direct Data Input for Database for Safety Equipment Items and Method

(75) Inventors: Dean R. Kaartinen, Lake City, MN (US); Bruce D. Underwood, Lakeville, MN (US)

Correspondence Address: IPLM GROUP, P.A., POST OFFICE BOX 18455, MINNEAPOLIS, MN, 55418, US

(73) Assignee: DB Industries, Inc.

(21) Appl. No.: 11/759,152

(22) Filed: Jun. 6, 2007

Related U.S. Application Data
(60) Provisional application No. 60/811,809, filed on Jun. 8, 2006.

(51) Int. Cl. G06F 3/01

(52) U.S. Cl. 707/10

(57) ABSTRACT

Database control system for information relating to a plurality of safety equipment items produced by a producer and method. A centrally controlled database contains information representative of information related to each of the plurality of safety equipment items, each of the plurality of safety equipment items being associated with a unique identifier and each of the plurality of safety equipment items being associated with one of a plurality of customers. Computer equipment is associated with one of the plurality of customers having the capability of accessing a portion of the information of the database associated with the one of the plurality of customers. A remote data entry device is associated with the one of the plurality of customers for data input associated with a plurality of safety equipment items associated with the one of the plurality of customers, the data input being directly updated into the centrally controlled database.

### RELATED APPLICATIONS

This disclosure is related to the following co-pending applications filed on even date herewith: (1) “Method of Facilitating Controlled Flow of Information for Safety Equipment Items and Database Related Thereto” by Dean R. Kaartinen and Bruce D. Underwood, Attorney Docket No. 221P176USU1; (2) “Methods of Retrofitting Safety Equipment Items and Database” by Dean R. Kaartinen and Bruce D. Underwood, Attorney Docket No. 221P179USU1; and (3) “Centralized Database of Information Related to Inspection of Safety Equipment Items Inspection and Method” by Dean R. Kaartinen and Bruce D. Underwood, Attorney Docket No. 221P180USU1, which are not admitted as prior art with respect to the present disclosure by its mention in this section.

### FIELD

The present invention relates generally to the field of safety equipment items such as safety harnesses and information related thereto.

### BACKGROUND

Safety equipment items, such as safety harnesses, are important and potentially life-saving devices serving a very real purpose in the lives of those who climb or who work in environments where a fall is a significant danger.

Records of safety equipment items generally must be maintained to ensure that the safety equipment items meet applicable governmental regulations and industry standards as well as the standards of the user and organization for whom the user works. Such organization is usually, ultimately, the customer of the producer of safety equipment items, albeit sometimes through an intermediary such as a distributor.

Traditionally, records, such as inspection data, for safety equipment items are maintained manually, e.g., with a paper inspection record attached to a pocket or label attached to the safety equipment item. However, such manual papers records are prone to illegibility since such safety equipment is often subjected to adverse conditions such as dirt, oil and grease. Such adverse conditions may actually render the manual record unusable due to illegibility, thereby potentially bringing the equipment out of compliance with safety standards and threatening the safety of the user.

Further, paper records kept locally with each piece of safety equipment item are difficult to manage by an organization having a plurality or more than a few of such safety equipment items. Safety directors of such organizations often have a difficult time maintaining any sort organized data related to their safety equipment items since the records may be kept manually and locally with each piece of safety equipment item.

Even when organized records are kept by a safety director, such records are difficult to maintain and keep up to date since such equipment items may be physically disparately located and the actual record may be still be recorded manually and locally, and subject to deterioration and illegibility.

### SUMMARY

To facilitate the maintenance of reliable and easily accessible information related to safety equipment, an electronic database, controlled by the producer of the safety equipment, has been created. Equipment produced by the producer is tagged with an identifier, preferably a radio frequency ID (RFID) tag with a unique ID number, and entered into the database. Alternative, equipment produced by other producer's may be retroactively fitted with RFID tags and entered into the database. When the equipment is distributed to a user, the user, scans the RFID tag with handheld electronic equipment, preferably an adapted personal digital assistant (PDA), which begins an electronic session relating to that particular, piece of safety equipment.

In the session, the user may review information relating to the safety equipment stored on the RFID tag displayed on the PDA's screen. In addition, the user may enter new information pertaining to the equipment into the PDA's memory, including information related to where the equipment is being used, who is using it, and the occurrence and result of safety inspections of the equipment. The PDA is then placed in a docking station connected to a personal computer, which is itself connected to the internet, though applications are anticipated in which the PDA connects to the internet directly via a wireless link. The PDA is synchronized with the electronic database, and any information that had been entered is downloaded into the appropriate records in the database. Thus, after synchronization, the information becomes available to any user who has an account and access to the internet.

Because the central database is maintained by the producer of the equipment, the producer retains the ability to likewise update entries and post notices for users of particular equipment. Notices may include reminders that equipment inspections are due, or that a piece of equipment is nearing the end of its safe and useful life. In addition, new usage guidelines may be delivered to a user in the event that such guidelines have changed.

In an embodiment, the present invention provides a database control system for information relating to a plurality of safety equipment items produced by a producer. A centrally controlled database contains information representative of information related to each of the plurality of safety equipment items, each of the plurality of safety equipment items being associated with a unique identifier and each of the plurality of safety equipment items being associated with one of a plurality of customers. Computer equipment is associated with one of the plurality of customers having the capability of accessing a portion of the information of the database associated with the one of the plurality of customers. A remote data entry device is associated with the one of the plurality of customers for data input associated with a plurality of safety equipment items associated with the one of the plurality of customers, the data input being directly updated into the centrally controlled database.

In an embodiment, the present invention provides a method of controlling information flow in a database containing information relating to a plurality of safety equipment items produced by a producer, the database containing information representative of information related to each of the plurality of safety equipment items, each of the plurality of safety equipment items being associated with a unique identifier and each of the plurality of safety equipment items being associated with one of a plurality of customers. A portion of the information contained in the database associated with the one of the plurality of customers is accessed by one of the plurality of customers. Data associated with a plurality of safety equipment items associated with the one of the plurality of customers is remotely entered directly updating the centrally controlled database.

In an embodiment, the centrally controlled database is controlled by the producer.

In an embodiment, the data input bypasses the computer equipment of the one of the plurality of customers used to access the portion of information of the database associated with the one of the plurality of customers.

In an embodiment, the data input bypasses the computer equipment of the one of the plurality of customers.

In an embodiment, the remote data entry device comprises a personal digital assistant (PDA).

In an embodiment, the personal digital assistant utilizes XML to access the centrally controlled database.

In an embodiment, the data input comprises data associating one of the plurality of safety equipment items with a user of the one of the plurality of safety equipment items.

In an embodiment, the data input comprises data indicative of a service status of one of the plurality of safety equipment items.

In an embodiment, the data input comprises data related to inspection of one of the plurality of safety equipment items.

### DRAWINGS

FIG. 1 is a functional block diagram of a controlled database system for safety equipment items;

FIG. 2 is an elementary flow chart representation of exemplary functions of a controlled database system for safety equipment items;

FIG. 3 is a close-up screen shot of a mobile device useful in a controlled database system for safety equipment information;

FIG. 4 is a description of XML language running on mobile device;

FIG. 5 is a screen shot illustrating the step of associating safety equipment item with unique identifier;

FIG. 6 is a screen shot displaying information pertaining to users of a controlled database;

FIG. 7 is a screen shot used to associate safety equipment item with a customer;

FIG. 8 is a screen shot of a welcome screen;

FIG. 9 is a screen shot of a general information screen;

FIG. 10 is a screen shot of an equipment information screen;

FIG. 11 is a screen shot displaying safety equipment associated with a customer;

FIG. 12 is a screen shot of an inspection procedure;

FIG. 13 is a screen shot allowing input of a request for an inspection log report;

FIG. 14 is a screen shot allowing input of a request for an inventory report;

FIG. 15 is a flow chart illustrating aspects of an embodiment of a controlled database of safety equipment items;

FIG. 16 is a flow chart illustrating aspects of direct entry of data into a controlled database of safety equipment item;

FIG. 17 is a flow chart illustrating aspects of retrofit of safety equipment items with unique identifiers;

FIG. 18 is a flow chart illustrating aspects of a controlled database of safety equipment items related to inspection;

FIG. 19 is a screen shot of an assign screen;

FIG. 20 is a screen shot of an inspect screen;

FIG. 21 is a screen shot of an inspecting equipment screen;

FIG. 22 is a screen shot of an inquire screen;

FIG. 23 is a screen shot displaying the action taken during synchronization of mobile device;

FIG. 24 is a screen shot of a settings screen;

FIG. 25 is a screen shot of test connection screen;

FIG. 26 is a screen shot of a put in service screen;

FIG. 27 is a screen shot of a take out of service screen;

FIG. 28 is a screen shot displaying inspection status information; and

FIG. 29 is a screen shot of details pertaining to safety equipment.

### DETAILED DESCRIPTION

The entire content of the following co-pending applications are hereby incorporated by reference in their entirety: (1) “Method of Facilitating Controlled Flow of Information for Safety Equipment Items and Database Related Thereto” by Dean R. Kaartinen and Bruce D. Underwood, Attorney Docket No. 221P176US01; (2) “Method of Facilitating Controlled Flow of Information for Safety Equipment Items and Database Related Thereto” by Dean R. Kaartinen and Bruce D. Underwood, U.S. Provisional Patent Application Ser. No. 60/811,894 filed Jun. 4, 2006; (3) “Direct Data Input for Database for Safety Equipment Items and Method” by Dean R. Kaartinen and Bruce D. Underwood, U.S. Provisional Patent Application Ser. No. 60/811,809 filed Jun. 8, 2006, (4) “Method of Retrofitting Safety Equipment Items and Database” by Dean R. Kaartinen and Bruce D. Underwood, Attorney Docket No. 221P179US01; (5) “Method of Retrofitting Safety Equipment Items and Database” by Dean R. Kaartinen and Bruce D. Underwood, U.S. Provisional Patent Application Ser. No. 60/811,808 filed Jun. 8, 2006, (6) “Centralized Database of Information Related to Inspection of Safety Equipment Items Inspection and Method” by Dean R. Kaartinen and Bruce D. Underwood, Attorney Docket No. 221P180US01; (7) “Centralized Database of Information Related to Inspection of Safety” by Dean R. Kaartinen and Bruce D. Underwood, U.S. Provisional Patent Application Ser. No. 60/811,931, (8) “Retrofittable Radio Frequency Identification Tag” by Brent J. Knoll and Bradley A. Rohlf, U.S. Provisional Patent Application Ser. No. 60/811,965 filed Jun. 8, 2006, and (9) “Retrofittable Radio Frequency Identification Connectors” by Brent J. Knoll and Bradley A. Rohlf, U.S. Provisional Patent Application Ser. No. 60/856,607 filed Nov. 3, 2006.

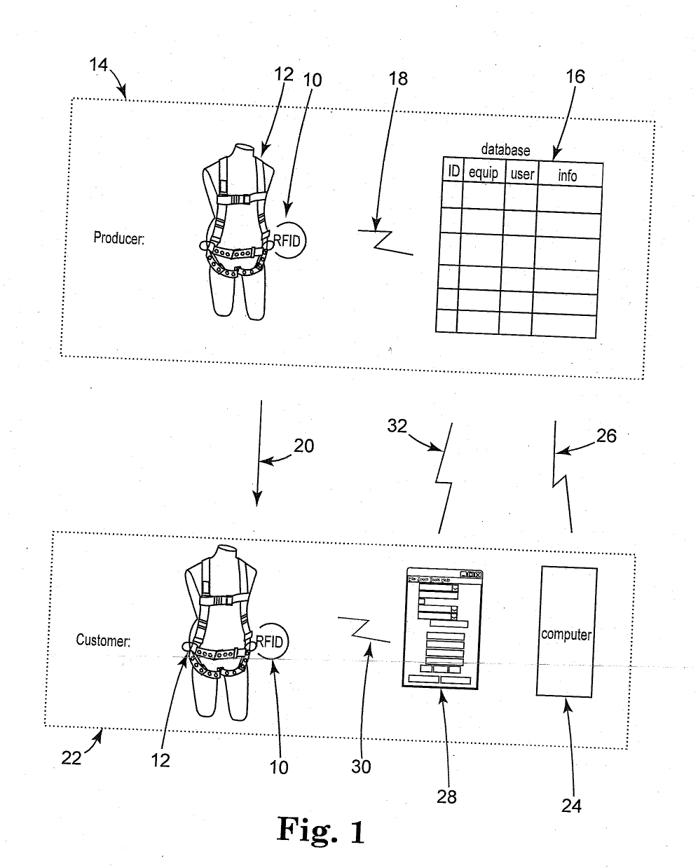

FIG. 1 illustrates a functional block diagram in which a unique identifier 10, such as radio frequency identification (RFID) tag is applied, for example by permanent stitching, to safety equipment item 12. It is to be recognized and understood that unique identifier 10, in the form of radio frequency identification tag 12 may be applied to or affixed to safety equipment item 12 in a variety of manners, including, but not limited to, putting unique identifier 10 into a pouch that is then sewn onto safety equipment item 12, affixing unique identifier to safety equipment with a strap or cord, adhesively mounting unique identifier to a portion of safety equipment item 12, magnetically attached unique identifier 10 to a metallic element of safety equipment item 12, putting unique identifier 10 into a container or pouch of safety equipment item 12, attaching unique identifier 10 to a tag, label or other item attached to safety equipment item 12, or by keeping unique identifier in a container, package, case, cover or other holding or protective device associated with safety equipment item 12.

An example of an application technique for associated unique identifier 10 with safety equipment item 12 is used by EXOFIT XP™ safety harness model 1110102 manufactured by D B Industries, Inc., Red Wing, Minn.

Safety equipment item 12 is illustrated as a safety climbing harness. However, it is to be recognized and understood that safe equipment item 12 could be any of a variety of safety equipment including, but not limited to, anchors and anchorage connectors, body belts and harnesses, lifelines, netting systems, load arrestors and lanyards.

Radio frequency identification tag 12 provides a unique identifier 10 that can be associated with an individual one of a plurality of safety equipment items manufactured by, or produced by, producer 14. While radio frequency identification tag is preferred as the unique identifier, it is to be recognized and understood that other unique identifiers could also be utilized such as, but not limited to, bar codes and serial numbers. Radio frequency identification tag provides an advantageous unique identifier 10 since the unique identifier 10 can be readily determined using commonly available RFID scanning equipment.

Producer 14 may associate unique identifier 10 with a particular one of safety equipment items 12 manufactured by, or produced by, producer 14. Such database 16 is preferably controlled by producer 14 and may be physically located at a site of producer 14 or off-site but still controlled by producer 14 such as at a contract location.

The association between safety equipment items 12 and their respective unique identifier 10 may be stored in database 16 which is used to contain information related to safety equipment item 12. Database 16 may contain information including, but not limited to, information related to safety equipment item 12, information related to a distributor or customer of a safety equipment item 12, information related to a user of a safety equipment item 12, information related to sales of or a location of storage or use of a safety equipment item 12, information related to usage, type of usage, dates of usage or of non-use of a safety equipment item 12, information related to inspection and/or condition of a safety equipment item 12, information related to manufacture and/or sale or lease of a safety equipment item 12 and information related to an inventory of safety equipment items 12. This information may be stored in database 16 in separate tables related by type or source of information or may be at least partially combined in common tables as is appropriate.

Producer 14 may obtain information regarding a particular safety equipment item 12 by reading or scanning 18 the particular safety equipment item 12 and obtaining unique identifier 10 associated with the particular safety equipment item 12. Such reading or scanning of unique identifier 10, such as an RFID tag, may easily be accomplished in a conventional and well known manner. Information related to the particular safety equipment item 12 may then either be obtained from database 16 or input into database 16 by producer 14 through conventional means.

Following production, producer 14 may put safety equipment item 12 into chain of commerce 20, for example, by selling or leasing safety equipment item 12 to customer 22. While the following description focuses on customer 22, it is to be recognized and understood that the term customer 22 may mean anyone or any entity downstream in chain of commerce 20 from producer 14. Customer 22, for example, may include a distributor or representative of safety equipment item 12.

Customer 22 may have electronic equipment, such as computer 24, to access a portal 26 to database 16 through a wide-area network, such as the internet. Customer 22 may access database 16 to receive information concerning safety equipment 12 associated with such customer 22 including, but not limited to, safety equipment information such as date of manufacture, service date and/or service history, size, color or other characteristic, assigned user (if any), inspection data, upcoming inspection events and/or inspection history.

Portal 26 may also be used with customer 22 to push information from producer 14 to customer 22 without any overt customer action. That is, since database 16 exists in the control of producer 14, producer 14 may utilize knowledge of association of a particular safety equipment item 12 with a particular customer 22 or user to enhance the life cycle operation of such safety equipment item 12. Information about an upcoming inspection event or due date, length of service information and the like may assist customer 22 in keeping safety equipment item 22 current, operational and safe. If safety equipment item 22 has a predetermined life usage time, then customer 22 may also be alerted relative to such usage life span, either, as an alert for an upcoming expiration or as a warning of such expiration.

Portal 26 may also be utilized with customer 22 to push important technical information to customer 22 about the particular safety equipment item or items 22 associated with such customer 22. Technical bulletins specifically targeted to such safety equipment item or items 22 may be “pushed,” or transmitted to customer 22 without overt action by such customer 22. If new or revised training procedures or requirements were to be recommended or established, such new or revised training procedures could be pushed to customer 22. Different training information, such as training videos, may be delivered to each individual customer 22 based on the specific safety equipment item or items 12 associated with such customer 22. If a governmental regulatory body, such as the Occupational Safety and Health Administration (OSHA) in the United States, were to establish new or revised safety requirements or guidelines, such information, specific to the safety equipment item or items 12 associated with such customer 22 may be pushed to that customer 22. Of course, safety organizations of other countries as CSA in Canada or EN in European countries may also be used.

Further, promotional material may be pushed to customer 22, again based specifically on the safety equipment item or items 12 associated with such customer 22. This is particularly valuable to a producer 14 who only sells through an intermediary, such as a distributor, and, hence, might not otherwise know what safety equipment items 12 were associated with a particular customer 22. The knowledge gained from database 16 allows a targeted promotional focus to only those customers 22 who have a particular model, or range of models or range of build codes, of such safety equipment items 12.

Additionally, user's manuals and cleaning and storage information may be made available to customer 22 or to the user.

Customer 14 may input data relating to safety equipment items 12 associated with such customer 22 into database 16. Examples of information that customer 22 may input to database 16 include, but is not limited to, the date such safety equipment item 12 is received, date a safety equipment item 12 is placed into or taken out of service, assignment or reassignment of a safety equipment item 12 to a user of such item 22, identification or modification of a location at which such item 22 is used or stored, maintenance information such as inspection dates, inspection passes/fails, inspection results, inspection records, repairs or modifications and date of disposition and type of disposition of such item 22, such as disposal, return or sale.

It is generally recognized that customer 22 may want or need to input any or all of such data from a location that is remote from the location of computer 24. Or even at the location of computer 24, it may be easier or more desirable to use a mobile device 28 for such data input. Mobile device 28 is illustrated in FIG. 1 as a personal digital assistant which facilitates ease of data entry while allowing such data entry to occur at a location where, or near where, safety equipment items 12 are located. For example, mobile device 28 may be used by customer 22 at or near a storage area for safety equipment items 12.

As such items are placed into service, assigned to users, inspected, repaired, retired, etc., mobile device 12 may be used to scan unique identifier 10 associated with each safety equipment item 12 and the pertinent data input into mobile device 28. Such scanning can be accomplished by well known scanning techniques 30 such as with RFID tags. In an embodiment, a scanning frequency of 134.2 KiloHertz is utilized for this purpose.

Mobile device 28 may then upload, or synchronize, the entered data directly to database 16 through communication link 32. Communication link 32 may be any of a number of standard, commonly available, communication links or a combination of such links. For example, mobile device 28 may communicate with a base station (not shown) using Blue Tooth or Wi-Fi networking. The base station may utilize a wide area network, such as the internet, as a portal to database 16.

In an embodiment, mobile device 28 communicates directly with database 16 controlled by producer 14. That is, customer 22 does not need to maintain a duplicate or shadow copy of database 16, or a portion thereof, in the control of customer 16. Mobile device 28 does not need to communicate through computer 24 used by customer to access portal 26 to database 16. Rather, mobile device 28 has a more direct connection with database 16. This is true even if communication link 32 has two or more technical aspects, e.g., Blue Tooth and internet. Customer 22 does not need to manipulate, screen, store (other than to synchronize) or modify the data entered into mobile device 28. Mobile device 28 only needs to act as a conduit to database 16.

Of course, it is to be recognized and understood that mobile device 28 may not be technically mobile. That is, mobile device 28 may be physically located only in one location and may not even be portable. Mobile device 28 could be a desk top personal computer that is located conveniently to a location where data entry occurs. However, in an embodiment, mobile device 28 is a hand held PDA that is portable and may be carried to the desired data entry location. An example of a hand held PDA suitable for this purpose is a HP iPAQ portable hand held marketed by HP. A distinction is that mobile device 28 does not need to be coupled with computer 24 nor perform other functions other than data entry and synchronization directly with database 16.

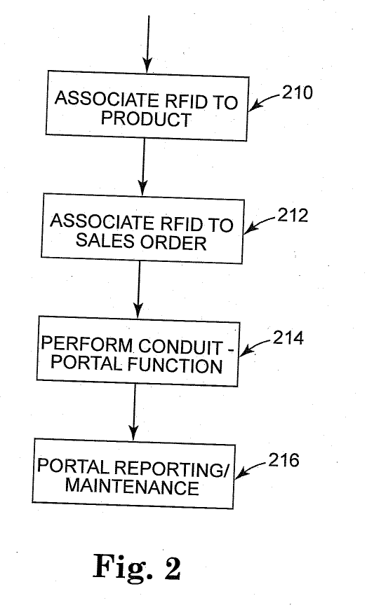

FIG. 2 is a flow chart representation of function associated with a safety equipment item 12 during the life cycle of such safety equipment item 12. Unique identifier 10, in this case an RFID tag, is associated (210) with safety equipment item 12 (product). This is typically done during or following completion of manufacture or production by producer 14 while safety equipment item 12 is still within the control of producer. That is, before producer 14 has placed safety equipment item 12 into a stream of commerce such as sale or lease. Although, as will be described later, unique identifier 10 may also be associated to safety equipment item 12 after such safety equipment item 12 has left the control of producer 14. This is the so-called retrofit situation. In either case, unique identifier 10 is associated with safety equipment item 12 not only physically, so that unique identifier may be subsequently recalled, but also in database 16.

When the safety equipment item 12 is placed into a stream of commerce, for example by sale, safety equipment item 12, through unique identifier 10, is associated (212) with a sales order, or, more specifically, to a customer of such sales order. If safety equipment item 12 subsequently is resold, given, traded or otherwise disposed of, data associated with the new “customer,” owner in this case, may then be “associated” with safety equipment item 12 in database 16.

Once customer 22 is associated with safety equipment item 12, customer 22 may access (214) portal 26 to database 16 to access information about safety equipment item 12. Customer 22 may also conduct (216) reporting on information contained in database 16 and/or maintenance, such as inspection, of safety equipment items for safety equipment items 12 associated with such customer 22.

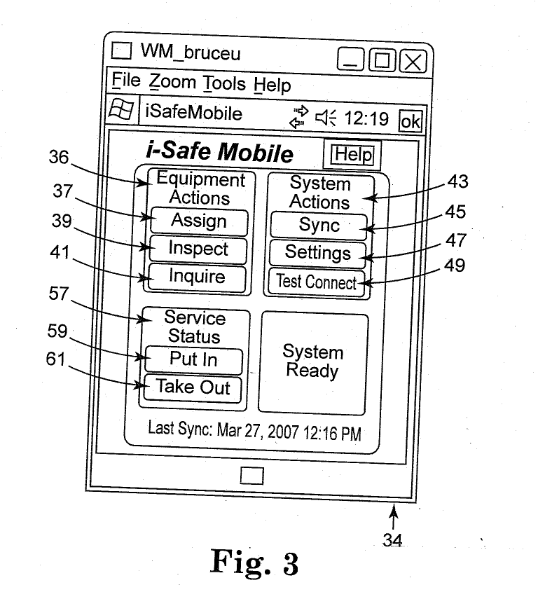

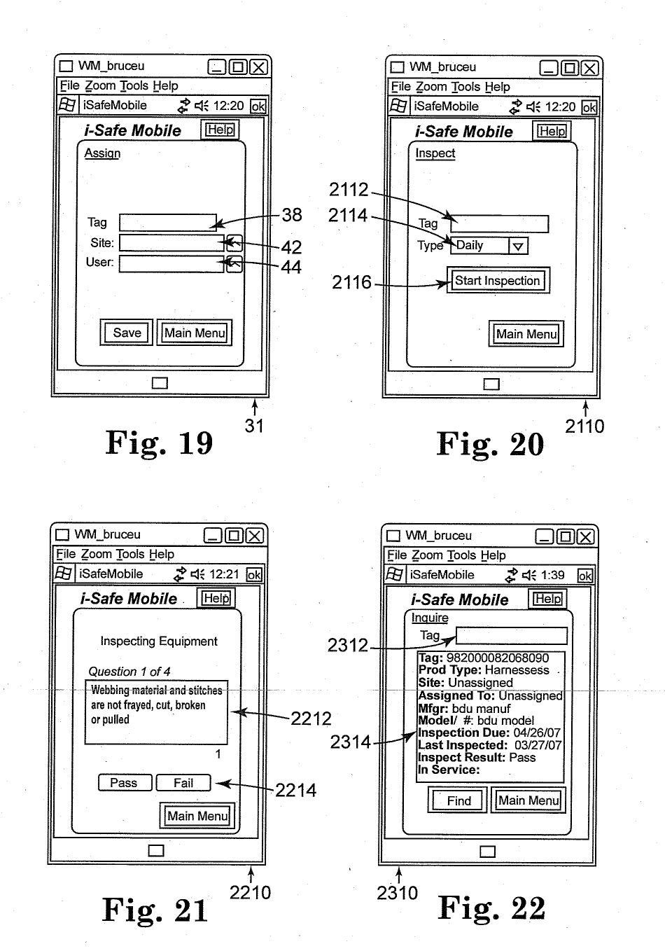

FIG. 3 is a close-up screen shot 34 of mobile device 28. Mobile device 28 runs a specialized XML language program to provide the data entry fields indicated in screen shot 34. Screen shot 34 provides equipment action field 36 allowing customer 22 to select an action with respect to which data is to be entered into database 16. A user may select Assign 37 to proceed to Assign screen 31 (FIG. 19) to assign safety equipment item 12 to an alternative user or site. A user may select Inspect 39 (FIG. 20) to conduct and record an inspection of safety equipment item 12. Or a user may select Inquire 41 (FIG. 22) to obtain information about safety equipment 12.

FIG. 19 depicts Assign screen 311. RFID field 38 holds the scanned value of unique identifier 10. Site field 42 is shown as a drop down selection, which may be determined by customer 22, for the location, generally the physical location, of safety equipment item 12. User field 44, also shown as a drop down selection, and which may also be determined by customer 22, associates safety equipment item 12 with a user of such safety equipment item 12.

FIG. 20 depicts Inspect screen 2110. Tag field 2112 displays the unique identifier 10 for safety equipment item 12, while drop-down type field 2114 allows the user to select the inspection that will be conducted. Once the inspection to be conducted has been selected the user taps Start Inspection button 2116 to begin the inspection and take user to Inspecting Equipment screen 2210.

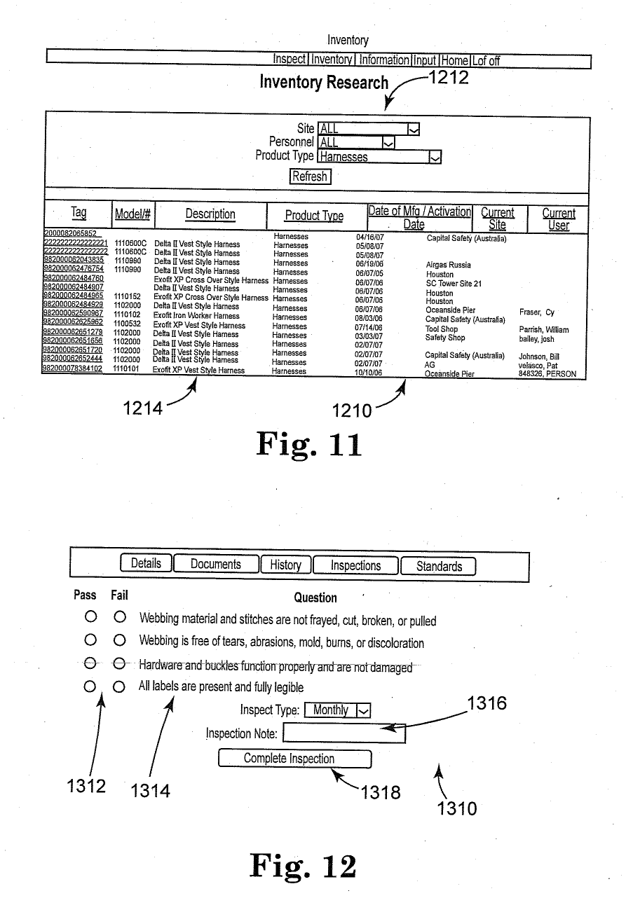

FIG. 21 depicts Inspecting Equipment screen 2210. Instruction window 2212 displays step-by-step instructions for conducting the inspection chosen in drop-down type field 2114. Once each step has been conducted, the user taps the Pass or Fail button 2214, as appropriate, and a new set of instructions is displayed in Instruction window 2212 until the all steps have been completed. The instructions displayed on Inspecting Equipment screen 2210 will correspond to questions 1314 (FIG. 12).

FIG. 22 depicts Inquire screen 2310. When a user enters unique identifier 10 of safety equipment item 12 into tag field 2312 and Find button 2316 is tapped, available information relating to safety equipment item 12 is displayed in window 2314. This information includes unique identifier 10, product type, assigned site, individual assigned to, manufacturer, model number, the date the next inspection is due, the date the most recent inspection occurred, the result of the inspection, and the date the safety equipment item 12 was put into service.

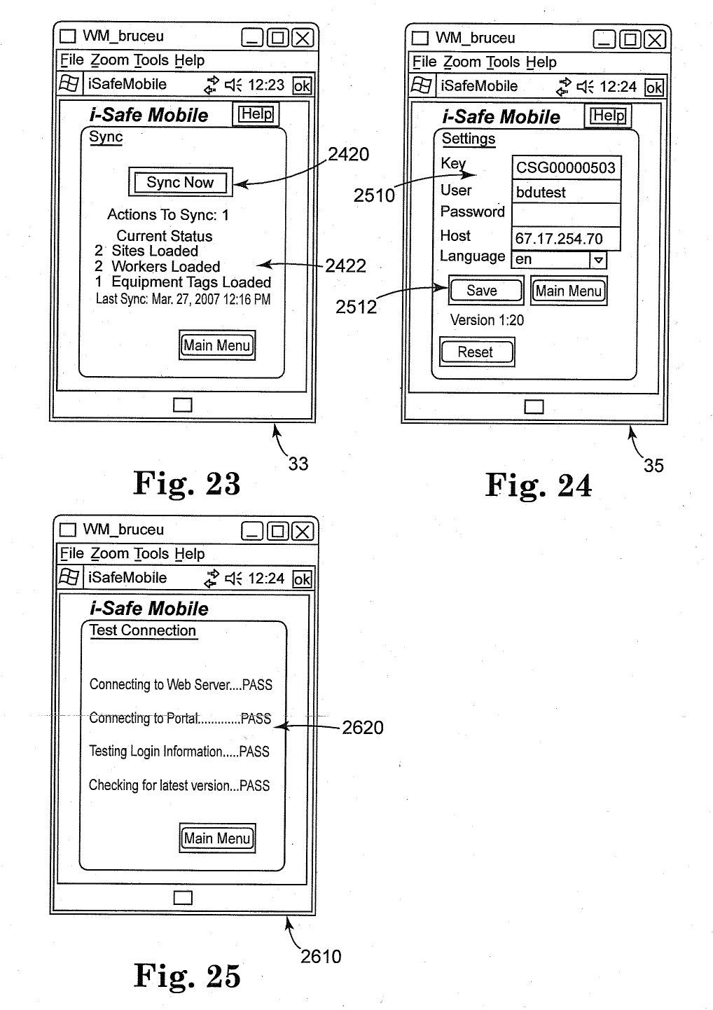

Again in FIG. 3, System action field 43 presents the user with options for system level activities unrelated to directly entering safety equipment item 12 information. Sync button 45 takes the user to Sync screen 33 (FIG. 23) which allows the user to sync mobile device 28 that is interfacing with computer 24 with database 16, uploading all safety equipment item 12 information that had been loaded on mobile device 28 since the date of the last sync 59. Settings button 47 takes the user to Settings screen 35 (FIG. 24) which allows the user to modify mobile device 28 settings such as a security key, user identification, website password, IP host address, and the language used by mobile device 28. Test Connect button 49 takes the user to Test Connection screen 2610 (FIG. 25) after conducting a connection test with the electronic hardware controlling database 16.

FIG. 23 depicts Sync screen 33. Sync Now button 2420 allows a user to initiate the synchronization of mobile device 28 with database 16. Current Status box 2422 provides the user with information relating to the information that is being downloaded to database 16, including the number of sites loaded, workers loaded, number of unique identifier numbers 10 loaded, and the date and time of the last sync.

FIG. 24 depicts Settings screen 35. Windows 2510 display mobile device's 28 security key, the identification of the user, the password, the host of mobile device 28, and the language used by mobile device 28. These values are subject to being changed by user and saved as mobile device's 28 settings by tapping Save button 2512.

FIG. 25 depicts Test Connection screen 25. Proceeding into the Test Connection screen 25 conducts a test of the connection between mobile device 28 and the electronic equipment containing database 16. The test will check the connection to the web server, the connection to the portal, the testing login information, and will check for the latest version of the interface software, and display the results in window 2620.

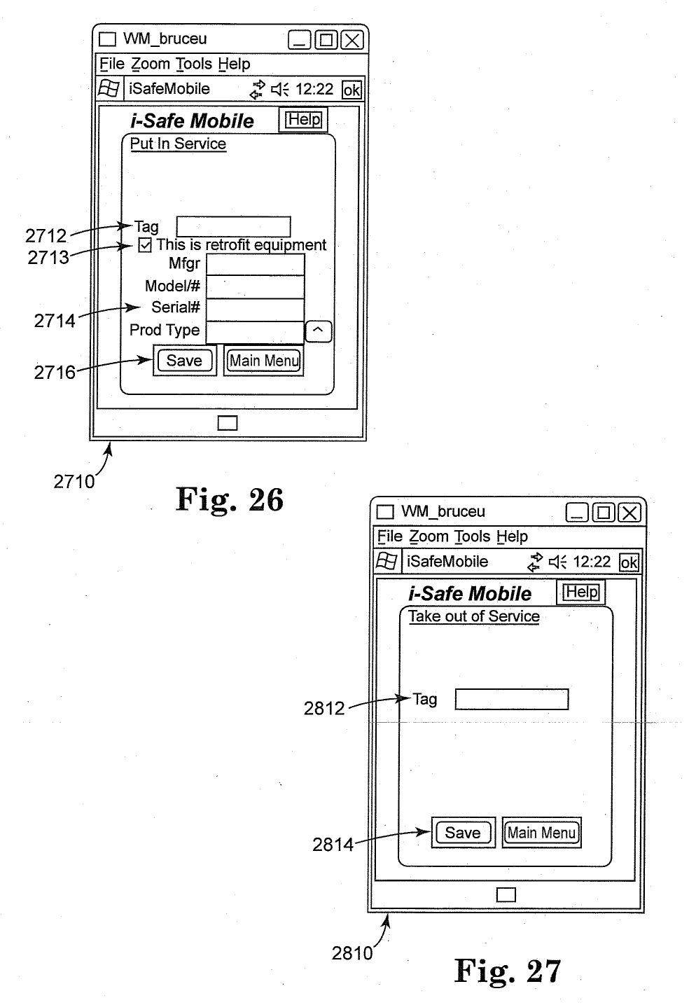

Again in FIG. 3, Service status field 57 presents the user with options for placing a particular safety equipment item 12 into service or taking it out of service. Put In button 59 brings the user to Put In Service screen 2710 (FIG. 26), allowing the user to indicate that safety equipment item 12 is being used on a regular and ongoing basis and thus must be subjected to regular inspections, which indication is stored in database 16. Take Out button 61 brings the user to Take out of Service screen 2810 (FIG. 27), allowing the user to take safety equipment item 12 out of service.

FIG. 26 depicts Put In Service screen 2710. When user enters unique identifier number 10 into Tag field 2712 and checks pick-box 2713 corresponding to whether the safety equipment item 12 is retrofitted with a unique identifier number 10 or not, user may enter data corresponding to unique identifier number 10 into fields 2714. By tapping save button 2716 user places safety equipment item 12 in service, and this status is stored in database 16, indicating that safety equipment item 12 must be subjected to regular safety inspections.

FIG. 27 depicts Take out of Service screen 2810. By entering unique identifier number 10 in Tag field 2812 and tapping save button 2814, the user may take the corresponding safety equipment item 12 out of service, which status will be stored in database 16.

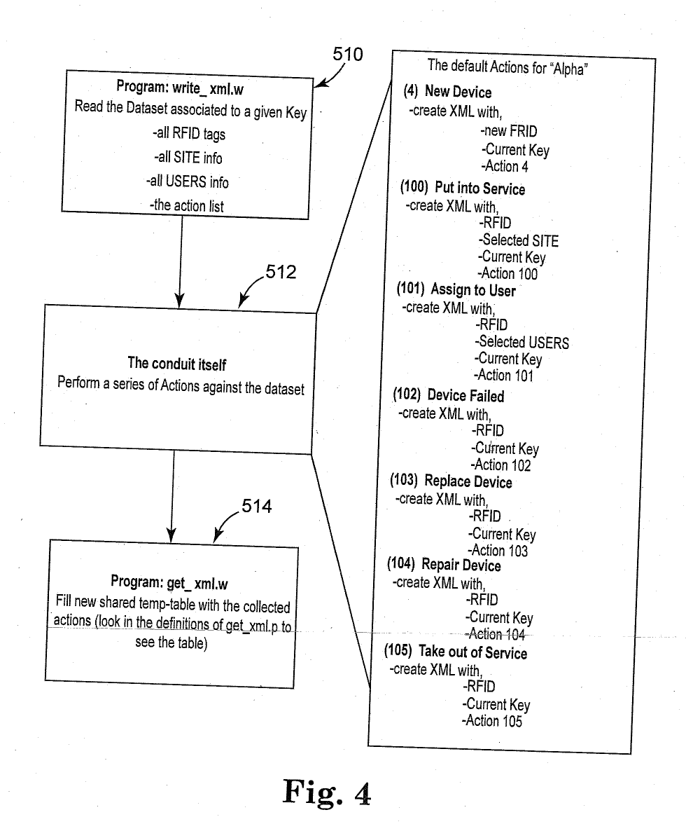

FIG. 4 describes with particularity the XML language program running on mobile device 28. Mobile device 28 will first read information from database 16 relating to the particular safety equipment item 12 whose unique identifier has been scanned. Mobile device 28 may then perform (512) at least one of the selected action items allowed for mobile device 28 such as creating (4) a new safety equipment item 12, putting (100) a safety equipment item 12 into service, assigning (101) a safety equipment item 12 to a user, indicating (102) that a safety equipment item has failed, replacing (103) a safety equipment item 12, repairing (104) a safety equipment item 12 and taking (105) a safety equipment item 12 out of service. The input data may then by synchronized (514) with information, if any, contained in database 16.

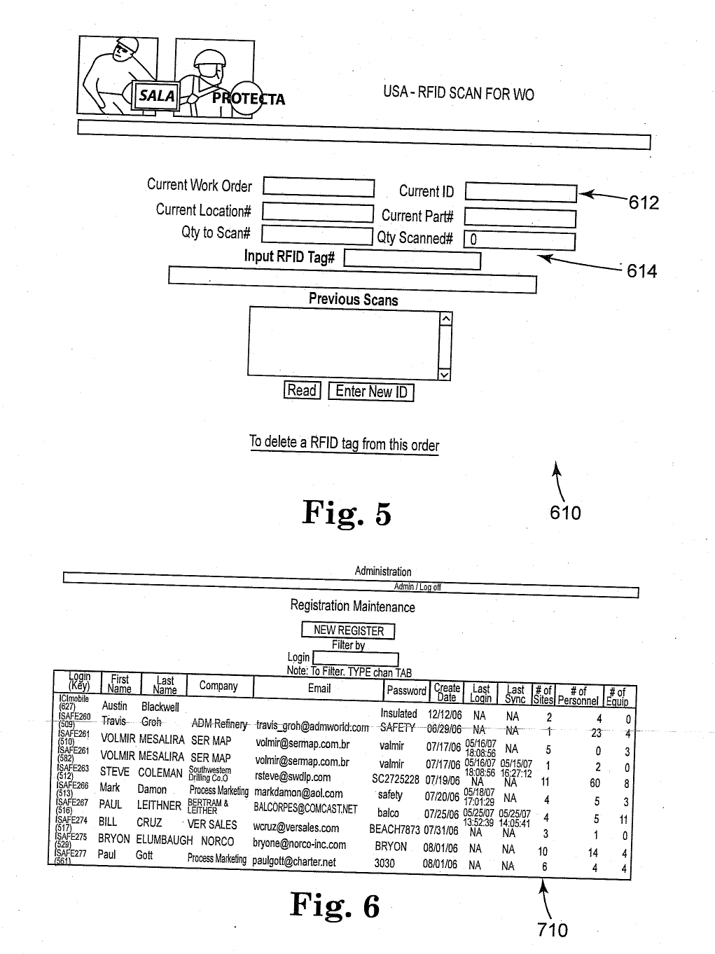

FIGS. 5 through 14, 28 and 29 illustrate screens shots of a program running on computer 24 by customer 22 or by a computer (not shown) by producer or by any other user of database 16. FIGS. 5 through 14, 28 and 29 provide an illustration of common tasks that may be performed with database 16.

FIG. 5 is a screen shot 610 illustrating the step of associating safety equipment item 12 with unique identifier 10 where producer 14 is producing safety equipment item 12 for a customer 22. This step may be accomplished by producer 14 during or following production of safety equipment item 12 such as in the factory at the completion of manufacture or production. The current ID number 612 may be the serial number of the safety equipment item 12. Screen shot 610 allows the display of data corresponding to safety equipment item 12 in fields 614 including the current work order, the current location and the current part number. The quantity of safety equipment items 12 to be scanned may be set and the quantity of safety equipment items 12 actually scanned. Generally, this screen shot may be set up for a plurality of safety equipment items 12 and then each unique identifier is scanned from each individual safety equipment item 12. Screen shot 610 displays the last action taken with respect to the scanned safety equipment item 12.

FIG. 6 is a screen shot 710 displaying information pertaining to users of database 16. Fields display the user's login key, name, email address, password, date their account was created, date of last login, date of last sync, number of sites related to the user, the number of personnel, and the number of safety equipment items 12 in the database 16.

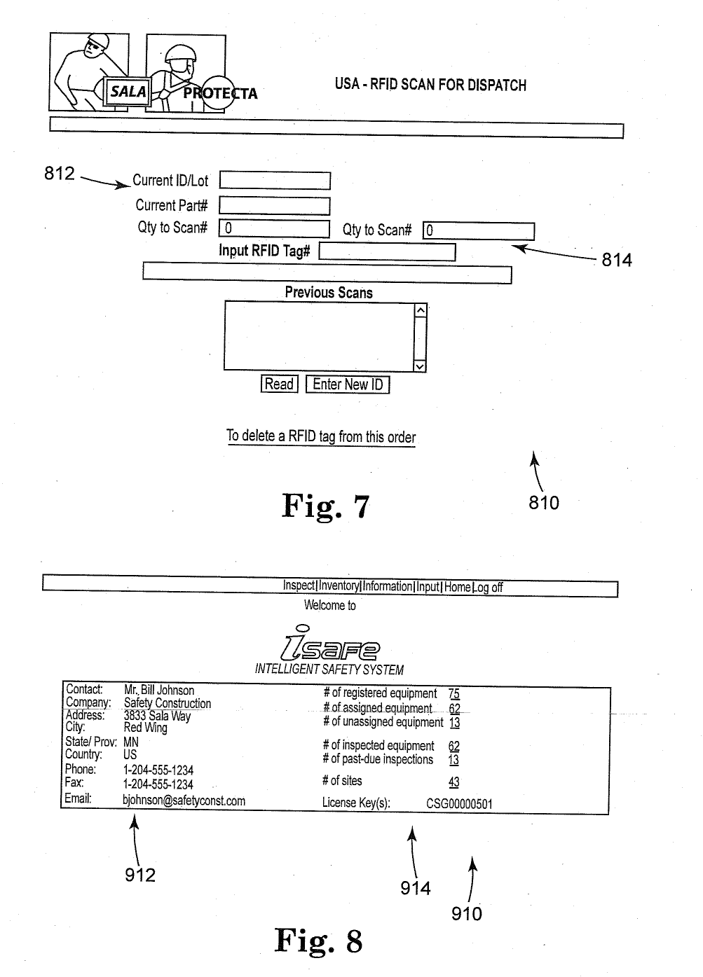

FIG. 7 is a screen shot 810 used to associate a safety equipment item 12 with a unique identifier 10 without reference to a particular, customer 22. Screen shot 810 allows for entry in fields 812 of a production lot ID number, a part number and the quantity of safety equipment items 12 to scan. Fields 814 display the total number of safety equipment items that have been scanned, corresponding unique identifier 10 and the action taken during the last scan.

FIG. 8 is a screen shot 910 of a welcome screen of a registered user of database 16 following authorized log-in to portal 26. Screen shot 910 includes customer information fields 912, including fields for the contact, the company, address, city, state/province, country, telephone number, facsimile number and email address. Screen shot 910 also displays registered product information fields 914, including fields for the number of safety equipment items 12 associated with this customer 22, the number of such items 12 that have been assigned to a user, the number of such items 12 that have not been assigned, the number of such items 12 that have been inspected, the number of such items 12 that are past-due for inspection, and the number of sites corresponding to the user. License key field 916 displays the customer's license key.

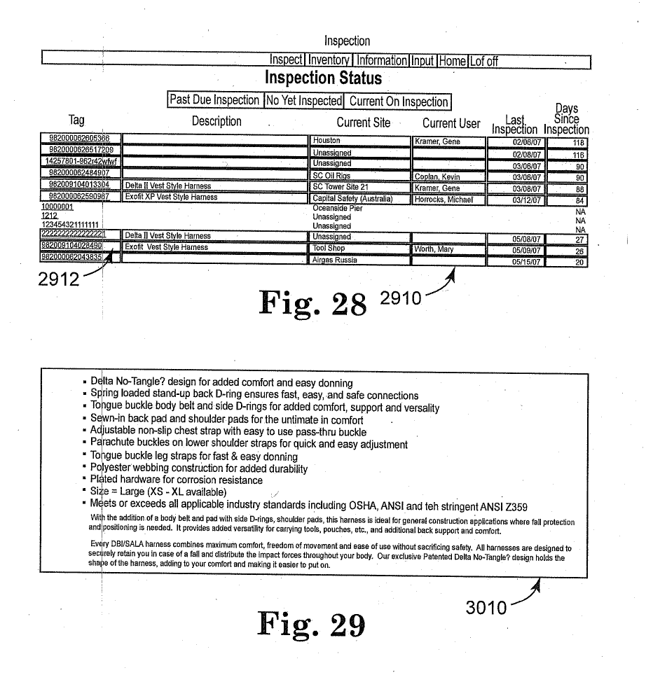

A button may lead from screen shot 910 to screen shot 2910 (FIG. 28), which displays inspection status information. Lines 2912 corresponding to individual safety equipment items 12 are color coded, corresponding to whether the individual safety equipment item 12 is overdue for inspection, has yet to be initially inspected, or is current on its inspections. Further, non-colored, information includes unique identifier 10, description, current site, current user, date of last inspection, and days since that inspection, for each safety equipment item 12.

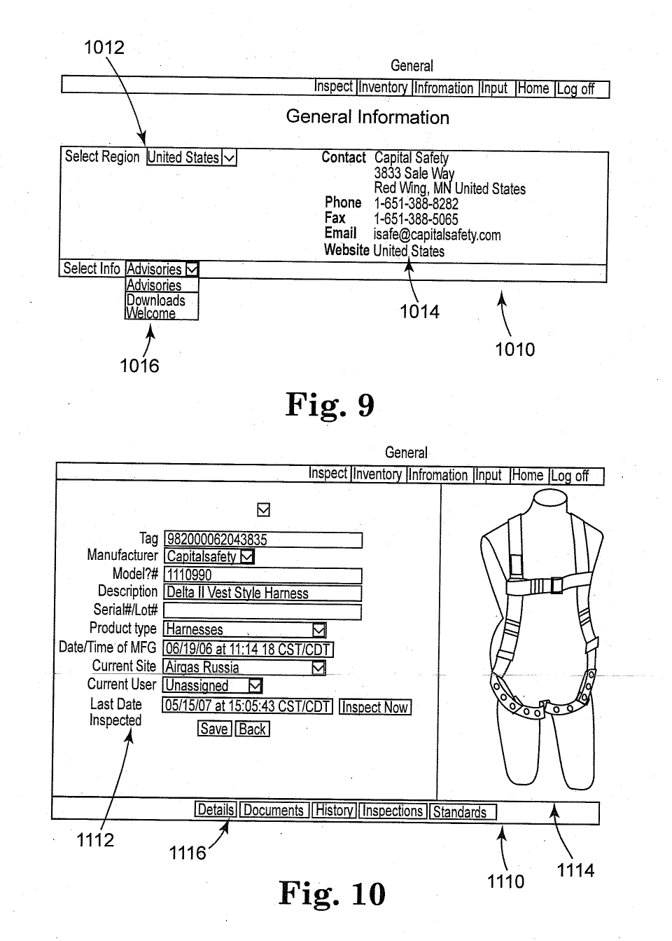

FIG. 9 is a screen shot 1010 of a general information screen. Drop-down menu 1012 allows a user to select their region, and then information relating to the region is displayed in field 1014. The information may include technical support information, including contact information such as address, phone and fax numbers, email address and website links. Drop-down menu 1016 also allows a user to display information relating subjects such as advisory messages, available downloads, applicable standards, and miscellaneous welcome messages. It is contemplated that screen shot 1010 may be expanded to include step-by-step instructions for conducing all necessary inspections, as well as reviewing all recently published regulatory statutes, professional association updates, product advisories, equipment instructions and training schedules, as well as providing links to user information.

FIG. 10 is a screen shot 1110 of an equipment information screen. Fields 1112 display information related to an RFID number, i.e., unique identifier 10, safety equipment item 12 number, type of equipment, the lot number of manufacture, the manufacturer, i.e., producer, the data and/or time of manufacture, the current location, the current user and last date inspected are input/displayed. A pictorial rendering of safety equipment item 12 is displayed in window 1114. Buttons 1116 allows for the selection and display of various notes and information relating to safety equipment item 12, including selection details, related documents, history, inspections, review standards and inspect now.

FIGS. 12 and 29 provide representative examples of the screens that display data corresponding to buttons 1116 (FIG. 10). The information is displayed in a window that drops down below screens shot 1110 (FIG. 10). FIG. 12 is a screen shot 1310 of an inspection procedure, arrived at by clicking Inspect Now button 1116. Radio buttons 1312 correspond to questions related to the inspection, with a user selecting a radio button 1312 corresponding to the answer to each question 1314. When each question 1314 has been answered the user enters what kind of inspection had been conducted and enters any specialized comments in fields 1316. The inspection is saved by clicking button 1318.

FIG. 29 is a screen shot 3010 of details pertaining to safety equipment item 12 arrived at by clicking details button 1116. Available information may include sizes available, standards met by safety equipment item 12, and details about materials and construction.

FIG. 11 is a screen shot 1210 displaying the safety equipment items 12 associated with the customer 22. Drop-down menus 1212 allow a user to narrow the scope of a search of safety equipment items 12 by specifying all or a subset of sites, users and product types. Once the search has been conducted, relevant information is displayed in window 1214. The information includes all relevant safety equipment items 12, and their unique identifier 10, model number, description, date of manufacture or activation date, current site and current user.

FIG. 13 is a screen shot 1410 allowing input into drop-down menus 1412 a request for an inspection log report. The user may select the relevant site, personnel and product type. The user may also select the format of the report. The report may be of the same format as that displayed in window 1414. Buttons 1416 allow a user to refresh the search based on the criteria entered in drop-down menus 1412, and to print the report.

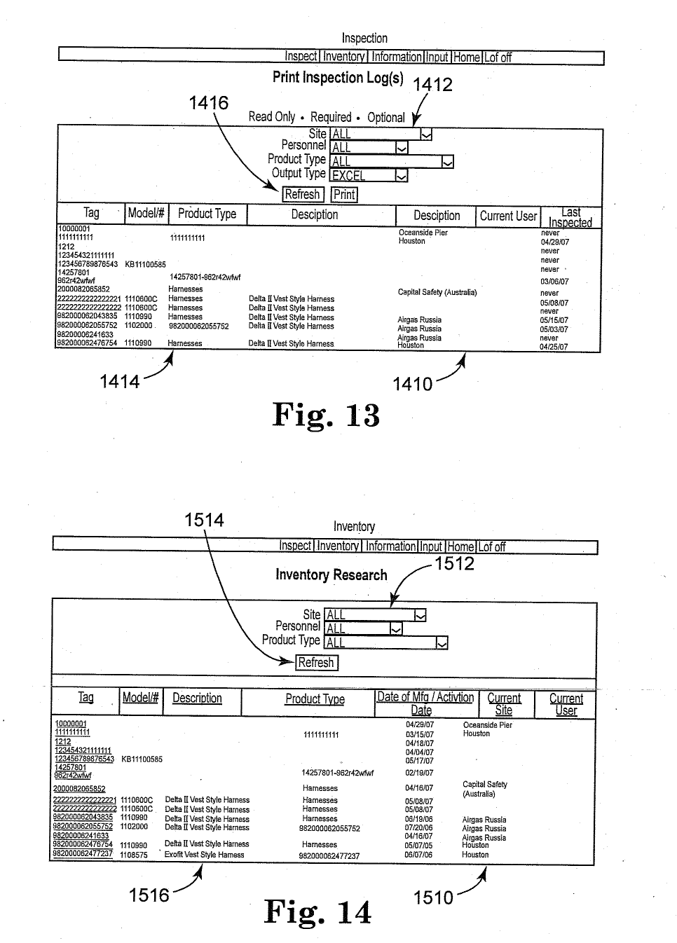

FIG. 14 is a screen shot 1510 allowing input into fields 1512 a request for an inventory report based on several criteria, such as site, personnel and product type. The data selected may then be viewed in window 1516 upon selection of the refresh button 1514.

Although the above description has mostly referred to the association of newly produced safety equipment items 12, namely safety equipment items 12 that have not yet passed out of control of producer 14 into a stream of commerce, it is to be recognized and understood that it is contemplated that safety equipment items 12 having already passed from the control of producer 14 may also be included in database 16 after having been associated with unique identifier. In an aspect, safety equipment items 12 are retrofit with a unique identifier and input into database 16, either by customer 16, by producer 14 or by another.

An example of attaching a unique identifier 10 to an already produced safety equipment item 12, i.e., retrofitting such safety equipment item 12 with a unique identifier 10, is described in co-pending U.S. Provisional Patent Application Ser. No. 60/811,965, entitled “Retrofittable Radio Frequency Identification Tag”, carrying Attorney Docket No. 221P182USP1 and U.S. Provisional Patent Application Ser. No. 60/856,607, entitled “Retrofittable Radio Frequency Identification Connector”, carrying Attorney Docket No. 221P182USP2. The apparatus for attaching unique identifier 10 to a retrofit safety equipment item 12 uniquely associates such retrofit safety equipment 12 with that unique identifier.

Retrofitting safety equipment items 12 with unique identifier 10 and including such association in database 16 achieves significant advantages. Customer 22 may immediately achieve establishment of database 16 containing not only new safety equipment items newly or recently purchased or acquired but instead allows customer 22 to move to the centralized database 16 approach to tracking or managing safety equipment items 12 without continuing to rely on old style paper records or fragmented electronic records. Without the retrofitting of existing safety equipment items 12, customer 22 would instead need to rely on other safety equipment item 12 management including management of inspection records. The necessity of having two management systems for one inventory of safety equipment items 12 would be a burden on customer 22 and might prevent customer 22 from being able to practically switch to the controlled database system described herein. Further, retrofitting existing safety equipment items 12 allows producer 14 to utilize controlled database 16 to communicate with customers 22 and users and be relatively assured that such customers 22 will receive appropriate information for all or most of their inventory of safety equipment items 12 rather than just newly produced safety equipment items 12.

Existing safety equipment items 12 manufactured or produced by producer 14 may be retrofit with unique identifier 10 and so associated in database 16. Additionally, existing or newly produced safety equipment items produced by another producer 14, i.e., by a producer not in control of database 16, may also be retrofit with unique identifier 10 and input into database 16. The retrofit of safety equipment items 12 not produced by producer 14 allows a customer 22 to include all or most of their inventory in database 16 even though not all of their inventory of safety equipment items 12 was produced by producer 14. Further, such retrofit also allows database 16 to be more of an industry-wide database utilizable across all producers. Such an industry-wide database could allow governmental agencies or industry associations to get word to the entire industry if desired or needed.

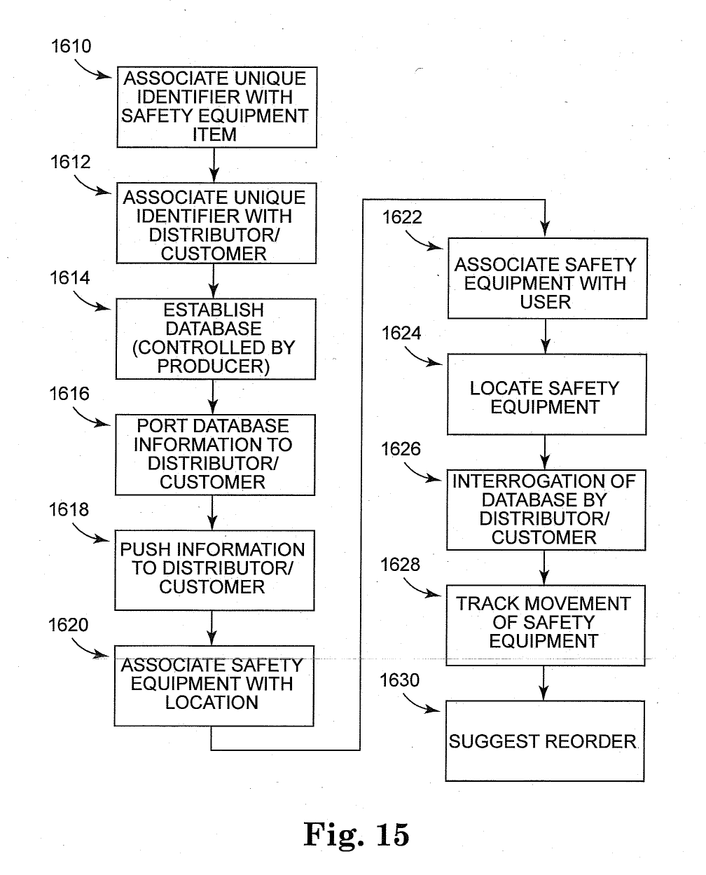

The following flow charts illustrate various aspects related to database 16 and various aspects of one or more of flow charts illustrated in FIG. 15 through FIG. 18 may include an embodiment or embodiments of the presently claimed invention.

FIG. 15 is a flow chart illustrating aspects of an embodiment of controlled database 16. Unique identifier 10 is associated (1610) with, e.g., applied or attached, to safety equipment item 12. If needed, a unique identifier 10 is associated (1612) with a customer 22 or distributor thereby associating safety equipment item 12 with such customer 22. Database 16 is established (1614) containing information related to safety equipment item 12 with unique identifier 10. Database 16 is ported (1616) to customer 22. If desired or needed, information is pushed (1618) to customer 22. If desired or needed, safety equipment item 12 may be associated (1620) with a location. If desired or needed, safety equipment item 12 may be associated (1622) with a user. Optionally, the information in database 16 may be used to locate (1624) safety equipment item 12. Optionally, customer 22 may interrogate (1626) database 16 to obtain information from database 16 relative to those safety equipment items 12 associated with that customer 22, e.g., the inventory report request illustrated in FIG. 14. Optionally, information in database 16 may be used to track (1628) the movement of safety equipment item 12. Optionally, the information in database 16 and portal 26 may be used by producer 14 to transmit marketing information to customer 22 such as suggesting a reorder of safety equipment item 12 or ancillary equipment.

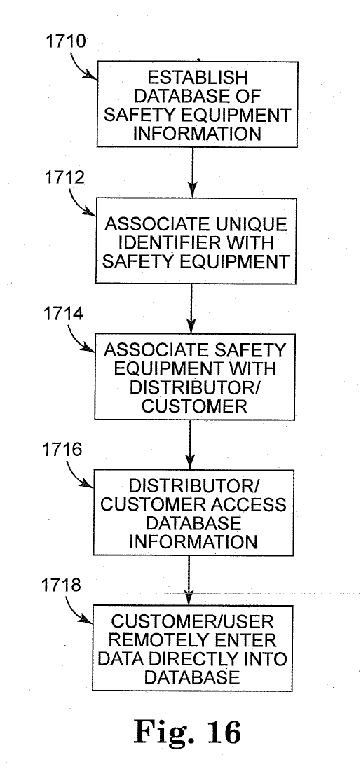

FIG. 16 is a flow chart illustrating aspects of an embodiment of controlled database 16 related to the direct entry of data into database 16. Database 16 of safety equipment information is established (1710). Safety equipment item 12 is associated (1712) with unique identifier 10. Safety equipment item 12, through unique identifier 10, is associated (1714) with a customer 22 or distributor. Optionally, such customer 22 or distributor accesses (1716) database 16 through portal 26. Customer 22 remotely enters data related to safety equipment item 12 associated with such customer 22 directly into database 16. Ideally, portal 26 need not be used for this purpose. Customer 22 does not maintain a duplicate database of information. Rather, data added or modified by customer 22 is directly entered into database 16 ensuring a common user-wide database of information related to safety equipment item 12.

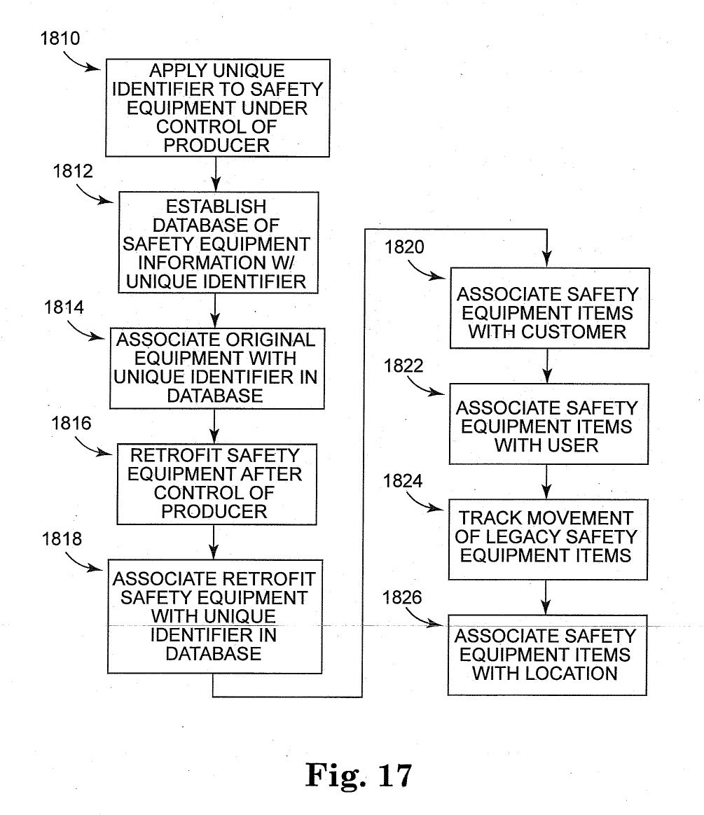

FIG. 17 is a flow chart illustrating aspects of an embodiment of controlled database 16 related to the retrofit of existing safety equipment items 12. Unique identifier 10 is applied (1810), preferably attached, to safety equipment item 12 under control of producer 14. Database 16 is established (1812) containing information related to safety equipment items 12 with unique identifiers 10. Safety equipment items 12 under the control of producer 14 are associated (1814) with unique identifier in database 16. If needed, safety equipment items 12 having passed from the control of producer 14 are retrofit (1816) with unique identifier 10. If needed, retrofit safety equipment items 12 are associated (1818) with unique identifier 10 in database 16. In some embodiments, safety equipment items 12 are associated (1820) with a customer and/or distributor. In some embodiments, safety equipment items 12 are associated (1822) with a user. In some embodiments, the movement or location of safety equipment items 12 are tracked (1824). If needed, such tracked or other safety equipment items 12 are associated (1826) with a location.

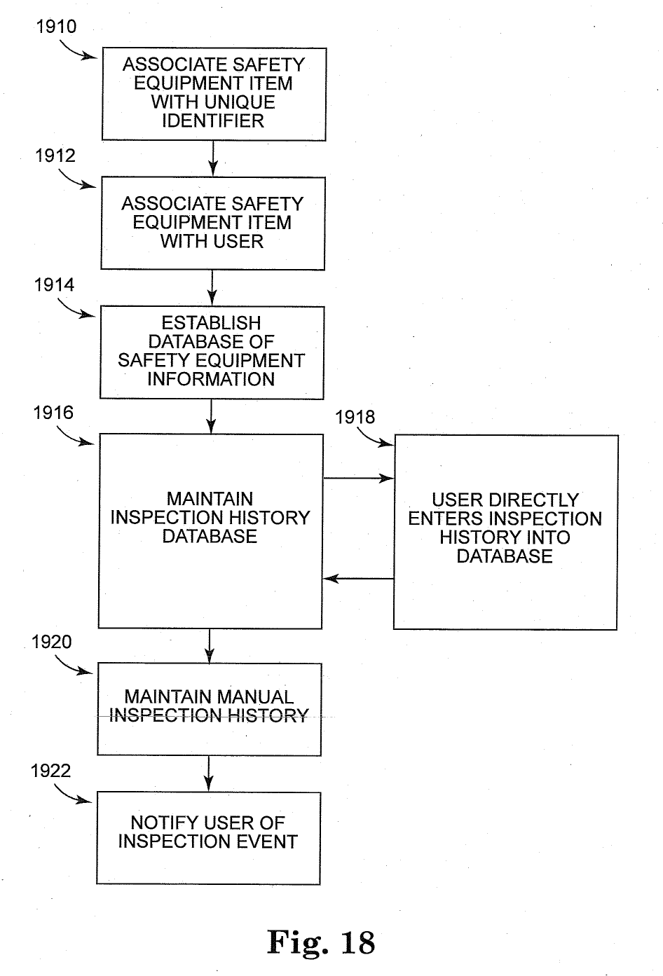

FIG. 18 is a flow chart illustrating aspects of an embodiment of controlled database 16 related to inspection. Unique identifier 10 is associated (1910) with, e.g., applied or attached, to safety equipment item 12. If needed, a unique identifier 10 is associated (1912) with a user thereby associating safety equipment item 12 with such user. Database 16 is established (1914) containing information related to safety equipment item 12 with unique identifier 10. An inspection history of safety equipment item 12 is maintained (1916) in database 16. User may directly enter (1918) inspection data directly into database 16 using, for example, mobile device 28. In so doing, database 16 continues to maintain (1916) an inspection history database. Optionally, user may also maintain (1920) inspection history, e.g., by marking a paper record attached to safety equipment item 12. Thus, a dual inspection history is maintained. The manual history kept locally with safety equipment item 12 as is now customary and which may still be required by governmental agencies and a more global electronic inspection history, not only for this safety equipment item 12 but also for other safety equipment items 12 associated with this user or customer 22 and even for other customers may both be kept. Both may be used, perhaps for different purposes. The manual local inspection record is familiar and can be accessed without specialized computer equipment. This may be advantageous in the field. The global electronic records is more useful for users or customers 22 having a plurality of safety equipment items 12 and enables such user or customer to have access, at once, inspection data and records on all of their safety equipment items 12 and enables such customers 22 or users to know when inspections are due and to schedule inspections accordingly. Optionally, the user may be notified (1922) of an inspection event.

Thus, embodiments of the method of facilitating controlled flow of information for safety equipment items and database related thereto are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A database control system for information relating to a plurality of safety equipment items produced by a producers, comprising:
a centrally controlled database containing information representative of information related to each of said plurality of safety equipment items, each of said plurality of safety equipment items being associated with a unique identifier and each of said plurality of safety equipment items being associated with one of a plurality of customers;
computer equipment associated with one of said plurality of customers having the capability of accessing a portion of said information of said database associated with said one of said plurality of customers; and
a remote data entry device associated with said one of said plurality of customers for data input associated with a plurality of safety equipment items associated with said one of said plurality of customers, said data input being directly updated into said centrally controlled database.

2. A database control system as in claim 1 wherein said centrally controlled database is controlled by said producer.

3. A database control system as in claim 1 wherein said data input bypasses said computer equipment of said one of said plurality of customers used to access said portion of information of said database associated with said one of said plurality of customer's.

4. A database control system as in claim 3 wherein said data input bypasses said computer equipment of said one of said plurality of customers.

5. A database control system as in claim 1 wherein said remote data entry device comprises a personal digital assistant (PDA).

6. A database control system as in claim 5 wherein said personal digital assistant utilizes XML to access said centrally controlled database.

7. A database control system as in claim 1 wherein said data input comprises data associating one of said plurality of safety equipment items with a user of said one of said plurality of safety equipment items.

8. A database control system as in claim 1 wherein said data input comprises data indicative of a service status of one of said plurality of safety equipment items.

9. A database control system as in claim 1 wherein said data input comprises data related to inspection of one of said plurality of safety equipment items.

10. A method of controlling information flow in a database containing information relating to a plurality of safety equipment items produced by a producer, said database containing information representative of information related to each of said plurality of safety equipment items, each of said plurality of safety equipment items being associated with a unique identifier and each of said plurality of safety equipment items being associated with one of a plurality of customers, comprising the steps of;
one of said plurality of customers accessing a portion of said information contained in said database associated with said one of said plurality of customers; and
remotely entering data associated with a plurality of safety equipment items associated with said one of said plurality of customers, said data input being directly updated into said centrally controlled database.

11. A method as in claim 10 wherein said centrally controlled database is controlled by said producer.

12. A method as in claim 10 wherein said data input bypasses said computer equipment of said one of said plurality of customers used to access said portion of information of said database associated with said one of said plurality of customers.

13. A method as in claim 12 wherein said data input bypasses said computer equipment of said one of said plurality of customers.

14. A method as in claim 10 wherein said remote data entry device comprises a personal digital assistant (PDA).

15. A method as in claim 14 wherein said personal digital assistant utilizes XML to access said centrally controlled database.

16. A method as in claim 10 wherein said data input comprises data associating one of said plurality of safety equipment items with a user of said one of said plurality of safety equipment items.

17. A method as in claim 10 wherein said data input comprises data indicative of a service status of one of said plurality of safety equipment items.

18. A method as in claim 10 wherein said data input comprises data related to inspection of one of said plurality of safety equipment items.
